(19) United States
(12) Patent Application Publication
(10) Pub. No.: US 2016/0137811 A1
(43) Pub. Date: May 19, 2016

(54) Ionizing Radiation Resistant Polycarbonate Resin Composition and Article Comprising the Same

(71) Applicant: Samsung SDI Co., Ltd., Yongin-si (KR)

(72) Inventors: Woo Suk CHEI, Uiwang-si (KR); Hyun Hye JANG, Uiwang-si (KR); Jun Ho CHI, Uiwang-si (KR); Jong Chan HUR, Uiwang-si (KR); O Sung KWON, Uiwang-si (KR)

(21) Appl. No.: 14/943,542

(22) Filed: Nov. 17, 2015

(30) Foreign Application Priority Data
Nov. 18, 2014 (KR) 10-2014-0161214

(51) Int. Cl. C08K 5/1515; C08K 5/053

(52) U.S. Cl. CPC C08K 5/1515; C08K 5/053

(57) ABSTRACT

A polycarbonate resin composition includes a polycarbonate resin; a polyalkylene glycol compound; and an epoxy ester compound comprising an ester group and an epoxy group. The polycarbonate resin composition can exhibit excellent properties in terms of color stability, hydrolysis resistance, thermal stability, and the like after irradiation with ionizing radiation.

### CROSS-REFERENCE TO RELATED APPLICATION

This application claims priority under 35 USC Section 119 to and the benefit of Korean Patent Application 10-2014-0161214, filed Nov. 18, 2014, the entire disclosure of which is incorporated herein by reference.

### FIELD

The present invention relates to an ionizing radiation resistant polycarbonate resin composition and a molded article including the same.

### BACKGROUND

Polycarbonate resins exhibit excellent mechanical and thermal properties and thus have been broadly used in various applications. For example, polycarbonate resins have been used as materials for medical appliances including medical devices, surgical instruments, and the like due to excellent properties thereof in terms of transparency, hygiene, rigidity, thermal resistance, and the like.

Such medical appliances require sterilization. Examples of sterilization methods include contact treatment using a sterilizing gas such as ethylene oxide and the like, heat treatment in an autoclave, and irradiation with ionizing radiation such as γ-rays, electron beams, X-rays, and the like. Contact treatment using ethylene oxide is not preferred due to toxicity of ethylene oxide, instability, and environmental problems relating to disposal of wastes, and the like. In addition, heat treatment in an autoclave can cause deterioration of resins during treatment at high temperature, provides burden of high energy costs, and requires a drying process to remove moisture from components after treatment. Thus, sterilization is typically performed using ionizing radiation, which allows treatment at low temperature and is relatively economical.

Polycarbonate resin, however, can suffer a yellowing phenomenon, deterioration in physical properties, and the like upon exposure to ionizing radiation. Accordingly, methods for stabilizing the polycarbonate resin by adding various additives have been proposed.

For example, a polycarbonate resin composition can be stabilized with respect to ionizing radiation for sterilization by including a poly(oxyalkylene) derivative and/or a sulfur-containing compound. EP 572889 A1, EP 732365 A1 and EP 611797 A1 are directed to resin compositions comprising a poly(oxyalkylene) derivative and disulfide. EP 794218 A2 is directed to a resin composition comprising a poly(oxyalkylene) derivative and sulfoxide or sulfone. EP 535464 A2 is directed to a resin composition comprising a poly(oxyalkylene) derivative and sulfonate. EP 664321 A1 and EP 742260 A1 are directed to resin compositions comprising a poly(oxyalkylene) derivative and sulfone amide.

However, these polycarbonate resin compositions do not exhibit sufficient stabilization with respect to the yellowing phenomenon. Moreover, the resin composition containing the sulfur-containing compound can exhibit deterioration in molecular weight, which can have adverse effects on the properties of the polycarbonate resin, and can also exhibit property deterioration due to lack of thermal stability upon injection molding.

Therefore, there is a need for a polycarbonate resin composition that can exhibit excellent properties in terms of color stability, hydrolysis resistance, and thermal stability after irradiation with ionizing radiation.

### SUMMARY OF THE INVENTION

Embodiments provide a polycarbonate resin composition, which can exhibit excellent properties in terms of color stability, hydrolysis resistance, thermal stability, and the like after irradiation with ionizing radiation, and a molded article including the same.

The polycarbonate resin composition may include a polycarbonate resin; a polyalkylene glycol compound; and an epoxy ester compound comprising an ester group and an epoxy group.

In exemplary embodiments, based on about 100 parts by weight of the polycarbonate resin, the polyalkylene glycol compound may be present in an amount of about 0.001 to about 5 parts by weight, and the epoxy ester compound comprising an ester group and an epoxy group may be present in an amount of about 0.001 to about 3 parts by weight.

In exemplary embodiments, the epoxy ester compound comprising an ester group and an epoxy group may be a compound represented by Formula 1:

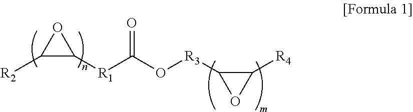

wherein R₁ and R₃ are the same or different and are each independently a C₁ to C₁₀ hydrocarbon group; R₂ and R₄ are the same or different and are each independently a hydrogen atom or a C₁ to C₁₀ hydrocarbon group; R₁ and R₂ may be optionally connected to each other to form a ring; R₃ and R₄ may be optionally connected to each other to form a ring; m and n are independently 0 or 1; and m+n is 1 or 2.

In exemplary embodiments, the content (amount) of the polyalkylene glycol compound may be larger than the content (amount) of the epoxy ester compound comprising an ester group and an epoxy group, and the sum of the contents (amounts) of the polyalkylene glycol compound and the epoxy ester compound may be about 0.002 to about 5 parts by weight based on about 100 parts by weight of the polycarbonate resin.

In exemplary embodiments, the polycarbonate resin composition may have a yellow index difference (ΔYI) of about 20 or less, as measured on a specimen having a thickness of about 3.2 mm and calculated according to Equation 1:

ΔYI=YI₁−YI₀ [Equation 1]

wherein YI₀ is the yellow index (YI) of a specimen of the polycarbonate resin composition having a thickness of about 3.2 mm, as measured in accordance with ASTM D1925 before irradiation with γ-rays, and YI₁ is the yellow index (YI) of the specimen, as measured in accordance with ASTM D1925 about 7 days after irradiation with γ-rays at about 25 kGy.

In exemplary embodiments, the polycarbonate resin composition may have a weight average molecular weight difference of about 1,600 g/mol or less and a yellow index difference (ΔYI) of about 0.6 or less, as measured on a specimen of the polycarbonate resin composition having a thickness of about 3.2 mm after treatment with steam under conditions of about 120° C. and about 2 bar for about 16 hours.

In exemplary embodiments, the polycarbonate resin composition may have a weight average molecular weight difference of about 1,800 g/mol or less and a yellow index difference (ΔYI) of about 0.9 or less, as measured on a specimen of the polycarbonate resin composition having a thickness of about 2.5 mm and prepared by injection molding after being left in an injection molding machine at about 320° C. for about 3 minutes.

Other embodiments relate to a molded article formed of the polycarbonate resin composition.

In exemplary embodiments, the molded article may include an ionizing radiation resistant medical appliance.

### DETAILED DESCRIPTION

Exemplary embodiments now will be described more fully hereinafter in the following detailed description, in which some, but not all embodiments of the invention are described. Indeed, this invention may be embodied in many different forms and should not be construed as limited to the embodiments set forth herein; rather, these embodiments are provided so that this disclosure will satisfy applicable legal requirements.

A polycarbonate resin composition according to the present invention has ionizing radiation resistance, and may include a polycarbonate resin; a polyalkylene glycol compound; and epoxy ester compound comprising an ester group and an epoxy group.

As the polycarbonate resin, any polycarbonate resin such as an aromatic polycarbonate resin used in a typical polycarbonate resin composition may be used without limitation. The polycarbonate resin may be prepared by, for example, a typical preparation method through reaction of a dihydric phenol compound with phosgene in the presence of a chain transfer agent and a catalyst, or through ester interchange of the dihydric phenol compound and a carbonate precursor.

Examples of dihydric phenol compounds may include without limitation 2,2-bis(4-hydroxyphenyl)propane (hereinafter, “bisphenol A”), hydroquinone, 4,4′-biphenol, bis(4-hydroxyphenyl)methane, 1,1-bis(4-hydroxyphenyl)cyclohexane, 2,2-bis(3-methyl-4-hydroxyphenyl)propane, 2,2-bis(3,5-dimethyl-4-hydroxyphenyl)propane, bis(4-hydroxyphenyl)sulfide, bis(4-hydroxyphenyl)sulfone, bis(4-hydroxyphenyl)sulfoxide, bis(4-hydroxyphenyl)ketone, bis(4-hydroxyphenyl)ether, halogenated bisphenols such as 2,2-bis(3,5-dibromo-4-hydroxyphenyl)propane, and the like, and mixtures thereof. It should be noted that the dihydric phenol compound capable of being used in the method for preparation of the polycarbonate resin is not limited thereto and the polycarbonate resin may be prepared using any dihydric phenol compound. In exemplary embodiments, bisphenol A may be used as the dihydric phenol compound. The bisphenol A may be partially or wholly substituted with another dihydric phenol compound such as listed herein.

In addition, the polycarbonate resin may be a homopolymer of one kind of dihydric phenol compound, a copolymer of two or more kinds of dihydric phenol compounds, or a mixture thereof.

Further, the polycarbonate resin may be prepared in the form of a linear polycarbonate resin, a branched polycarbonate resin, a polyester carbonate copolymer resin, and the like. The polycarbonate resin included in the polycarbonate resin composition according to the present invention is not limited to a specific form, and any of the linear polycarbonate resin, the branched polycarbonate resin and/or the polyester carbonate copolymer resin may be used as the polycarbonate resin.

As the linear polycarbonate resin, for example, a bisphenol A based polycarbonate resin may be used. The branched polycarbonate resin may be, for example, one produced by reacting a polyfunctional aromatic compound, such as trimellitic anhydride, trimellitic acid, and the like, with the dihydric phenol compound and the carbonate precursor. In addition, the polyester carbonate copolymer resin may be, for example, one produced by reacting bifunctional carboxylic acid with the dihydric phenol compound and the carbonate precursor. Furthermore, any typical linear polycarbonate resin, any typical branched polycarbonate resin, and/or any typical polyester carbonate copolymer resin may be used without limitation.

In exemplary embodiments, the polycarbonate resin may include a terminal modified polycarbonate resin having a tert-butylphenoxy group terminal. The terminal modified polycarbonate resin may be prepared by a typical method for preparing a polycarbonate resin except that tert-butylphenol is added in the preparation of the polycarbonate resin. The terminal modified polycarbonate resin may be present in an amount of about 0.1 mol % to about 80 mol %, for example, about 20 mol % to about 60 mol %, based on the total mol % (100 mol %) of the polycarbonate resin. Within this range, the polycarbonate resin composition can have further improved ionizing radiation resistance and impact resistance.

In exemplary embodiments, the polycarbonate resin may have a weight average molecular weight (Mw) of about 10,000 g/mol to about 200,000 g/mol, for example, about 15,000 g/mol to about 80,000 g/mol, as measured by gel permeation chromatography (GPC), without being limited thereto.

In addition, the polycarbonate resin may have a melt index (MI) of about 3 g/10 min to about 35 g/10 min, as measured in accordance with ISO 1133 (about 300° C. under a load of about 1.2 kg), without being limited thereto.

Examples of the polyalkylene glycol compound may include without limitation polyalkylene glycol, ethers of polyalkylene glycol, and/or esters of polyalkylene glycol. As the polyalkylene glycol compound, a polyol used in a typical ionizing radiation resistant composition may be used without limitation, and may include, for example, polyethylene glycol, polyethylene glycol methyl ether, polyethylene glycol dimethyl ether, polyethylene glycol dodecyl ether, polyethylene glycol benzyl ether, polyethylene glycol dibenzyl ether, polyethylene glycol-4-nonylphenylether, polypropylene glycol, polypropylene glycol methyl ether, polypropylene glycol dimethyl ether, polypropylene glycol dodecyl ether, polypropylene glycol benzyl ether, polypropylene glycol dibenzyl ether, polypropylene glycol-4-nonylphenyl ether, polytetramethylene glycol, polyethylene glycol diacetate, polyethylene glycol acetic propionate, polyethylene glycol dibutyrate, polyethylene glycol distearate, polyethylene glycol dibenzoate, polyethylene glycol di-2,6-dimethyl benzoate, polyethylene glycol di-p-tert-butyl benzoate, polyethylene glycol dicaprylate, polypropylene glycol diacetate, polypropylene glycol acetic propionate, polypropylene glycol dibutyrate, polypropylene glycol distearate, polypropylene glycol dibenzoate, polypropylene glycol di-2,6-dimethyl benzoate, polypropylene glycol di-p-tert-butyl benzoate, polypropylene glycol dicaprylate, and the like. These may be used alone or in combination thereof.

In exemplary embodiments, the polyalkylene glycol compound may have a number average molecular weight (Mn) of about 1,000 g/mol to about 5,000 g/mol, for example, about 1,500 g/mol to about 3,000 g/mol, as measured by gel permeation chromatography (GPC), without being limited thereto.

In exemplary embodiments, the polycarbonate resin composition may include the polyalkylene glycol compound in an amount of about 0.001 to about 5 parts by weight, for example, about 0.01 to about 2 parts by weight, based on about 100 parts by weight of the polycarbonate resin. In some embodiments, the polycarbonate resin composition may include the polyalkylene glycol compound in an amount of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, or 5 parts by weight. Further, according to some embodiments, the amount of the polyalkylene glycol compound can be in a range from about any of the foregoing amounts to about any other of the foregoing amounts.

Within this range, the polycarbonate resin composition can exhibit excellent color stability after irradiation with ionizing radiation.

The epoxy ester compound comprising an ester group and an epoxy group serves to enhance ionizing radiation resistance with minimal or no deterioration in hydrolysis resistance, and may include a compound represented by Formula 1.

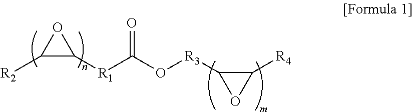

wherein R₁ and R₃ are the same or different and are each independently a C₁ to C₁₀ hydrocarbon group; R₂ and R₄ are the same or different and are each independently a hydrogen atom or a C₁ to C₁₀ hydrocarbon group; R₁ and R₂ may be optionally connected to each other to form a ring; R₃ and R₄ may be optionally connected to each other to form a ring; m and n are independently 0 or 1; and m+n is 1 or 2.

As used herein, the term C₁ to C₁₀ hydrocarbon group refers to substituted or unsubstituted C₁ to C₁₀ alkyl group, C₃ to C₁₀ cycloalkyl group, C₅ to C₁₀ aryl group, C₁ to C₁₀ alkylene group, C₃ to C₁₀ cycloalkylene group, and/or C₅ to C₁₀ arylene group. Also as used herein, the term “substituted” refers to one or more hydrogen atoms substituted with a substituent such as a halogen group, a C₁ to C₃₀ alkyl group, a C₁ to C₃₀ haloalkyl group, a C₆ to C₃₀ aryl group, a C₂ to C₃₀ heteroaryl group, a C₁ to C₂₀ alkoxy group, or a combination thereof. Also as used herein, when R₁ and R₂ and/or R₃ and R₄ are connected to each other to form a ring, the ring may include 4 to 10 carbon atoms and may be substituted or unsubstituted as defined herein.

Examples of the epoxy ester compound comprising an ester group and an epoxy group may include one or more compounds represented by Formulae 1a to 1c, without being limited thereto.

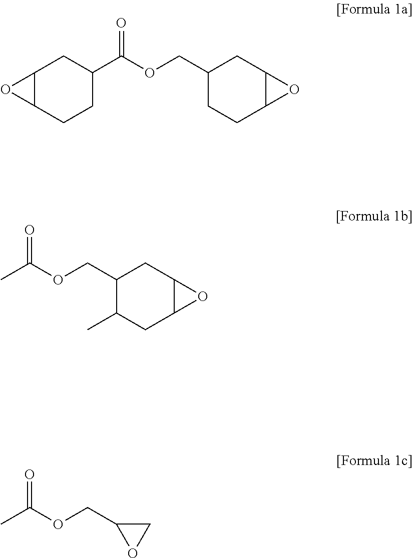

In exemplary embodiments, the polycarbonate resin composition may include the epoxy ester compound comprising an ester group and an epoxy group in an amount of about 0.001 to about 3 parts by weight, for example, about 0.01 to about 2 parts by weight, based on about 100 parts by weight of the polycarbonate resin. In some embodiments, the polycarbonate resin composition may include the epoxy ester compound comprising an ester group and an epoxy group in an amount of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, or 3 parts by weight. Further, according to some embodiments, the amount of the epoxy ester compound comprising an ester group and an epoxy group can be in a range from about any of the foregoing amounts to about any other of the foregoing amounts.

Within this range, the polycarbonate resin composition can exhibit excellent color stability after irradiation with ionizing radiation, with minimal or no deterioration in hydrolysis resistance, thermal stability, and the like.

In addition, the content (amount) of the polyalkylene glycol compound can be larger than the content (amount) of the epoxy ester compound comprising an ester group and an epoxy group, and the sum of the contents (amounts) of the polyalkylene glycol compound and the epoxy ester compound may range from about 0.002 to about 5 parts by weight, for example about 0.1 to about 3 parts by weight, with respect to about 100 parts by weight of the polycarbonate resin. In some embodiments, the polycarbonate resin composition may include the polyalkylene glycol compound and the epoxy ester compound comprising an ester group and an epoxy group in an amount of about 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, 3, 4, or 5 parts by weight. Further, according to some embodiments, the amount of the polyalkylene glycol compound and the epoxy ester compound comprising an ester group and an epoxy group can be in a range from about any of the foregoing amounts to about any other of the foregoing amounts.

Within this range, the polycarbonate resin composition can exhibit excellent color stability after irradiation with ionizing radiation, with minimal or no deterioration in hydrolysis resistance, thermal stability, and the like.

The polycarbonate resin composition according to the present invention may further include an allyl ether compound.

Examples of the ally ether compound may include trimethylolpropane diallyl ether, pentaerythritol diallyl ether, glycerin diallyl ether, and the like, and mixtures thereof, without being limited thereto.

In exemplary embodiments, the polycarbonate resin composition may include the ally ether compound in an amount of about 0.001 to about 3 parts by weight, for example, about 0.01 to about 2 parts by weight, based on about 100 parts by weight of the polycarbonate resin. In some embodiments, the polycarbonate resin composition may include the ally ether compound in an amount of about 0.001, 0.002, 0.003, 0.004, 0.005, 0.006, 0.007, 0.008, 0.009, 0.01, 0.02, 0.03, 0.04, 0.05, 0.06, 0.07, 0.08, 0.09, 0.1, 0.2, 0.3, 0.4, 0.5, 0.6, 0.7, 0.8, 0.9, 1, 2, or 3 parts by weight. Further, according to some embodiments, the amount of the ally ether compound can be in a range from about any of the foregoing amounts to about any other of the foregoing amounts. Within this range, the polycarbonate resin composition can exhibit further enhanced color stability after irradiation with ionizing radiation.

The polycarbonate resin composition according to the present invention may further include one or more of another resin without deteriorating advantageous effects of the present invention. Examples of the other resin may include without limitation polyethylene terephthalate, polybutylene terephthalate, polyester polycarbonate, and the like, and mixtures thereof. When the polycarbonate resin composition further includes another resin, the other resin may be present in an amount of about 50 parts by weight or less, for example, about 1 to about 15 parts by weight, based on about 100 parts by weight of the polycarbonate resin, without being limited thereto. In some embodiments, the polycarbonate resin composition may include the other resin in an amount of 0 (the other resin is not present), about 0 (the other resin is present), 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 31, 32, 33, 34, 35, 36, 37, 38, 39, 40, 41, 42, 43, 44, 45, 46, 47, 48, 49, or 50 parts by weight. Further, according to some embodiments, the amount of the other resin can be in a range from about any of the foregoing amounts to about any other of the foregoing amounts.

The polycarbonate resin composition may further include one or more additives which are typically used in a resin composition. Examples of the additives may include fillers, a reinforcing agent, a stabilizer, a coloring agent, an antioxidant, an antistatic agent, a flow improver, a release agent, and/or a nucleation agent, without being limited thereto. The additives may be used in an amount of about 25 parts by weight or less, for example, about 5 parts by weight or less, based on about 100 parts by weight of the polycarbonate resin, without being limited thereto.

The polycarbonate resin composition may be prepared by a method for preparing a thermoplastic resin known in the art. For example, the polycarbonate resin composition may be prepared in pellet form by mixing the components of the polycarbonate resin composition as set forth above with optional additives, followed by melt extrusion using an extruder, and the like. The prepared pellets may be formed into various articles by various molding methods, such as injection molding, extrusion molding, casting, and the like.

In exemplary embodiments, the polycarbonate resin composition according to the present invention may have a yellow index difference (ΔYI) of about 20 or less, for example, about 10 to about 20, as measured on a specimen having a thickness of about 3.2 mm and calculated according to Equation 1.

ΔYI=YI₁−YI₀ [Equation 1]

wherein YI₀ is the yellow index (YI) of a specimen of the polycarbonate resin composition having a thickness of about 3.2 mm as measured in accordance with ASTM D1925 before irradiation with γ-rays, and YI₁ is the yellow index (YI) of the specimen as measured in accordance with ASTM D1925 about 7 days after irradiation with γ-rays at about 25 kGy.

In exemplary embodiments, the polycarbonate resin composition may have a weight average molecular weight difference of about 1,600 g/mol or less, for example, about 100 g/mol to about 1,600 g/mol, and a yellow index difference (ΔYI) of about 0.6 or less, for example, about 0.1 to about 0.6, as measured on a specimen of the polycarbonate resin composition having a thickness of about 3.2 mm after treatment with steam under conditions of about 120° C. and about 2 bar for about 16 hours.

In exemplary embodiments, the polycarbonate resin composition may have a weight average molecular weight difference of about 1,800 g/mol or less, for example, about 100 g/mol to about 1,800 g/mol, and a yellow index difference (ΔYI) of about 0.9 or less, for example, about 0.1 to about 0.9, as measured on a specimen of the polycarbonate resin composition having a thickness of about 2.5 mm and prepared by injection molding after being left in an injection molding machine at about 320° C. for about 3 minutes.

Exemplary embodiments also include a molded article formed of the ionizing radiation resistant polycarbonate resin composition by a molding method known in the art. The molded article can exhibit excellent properties in terms of ionizing radiation resistance, hydrolysis resistance, thermal stability, impact resistance, and the like. Thus, the molded article according to the present invention may be advantageously used in ionizing radiation resistant medical appliances including container-type packages for receiving or packing syringes, intravenous injectors and surgical instruments, components of medical devices, such as artificial lungs, artificial kidneys, anesthesia inhalers, vein couplers, hemodialyzers, hemofilters, safety syringes and components thereof, and components of blood centrifuges, surgical instruments, intravenous injectors, and the like.

Hereinafter, the present invention will be described in more detail with reference to the following examples. It should be understood that these examples are provided for illustration only and are not to be construed in any way as limiting the present invention.

Descriptions of details apparent to those skilled in the art will be omitted for clarity.

### EXAMPLES

Details of components used in the following Examples and Comparative Examples are as follows:

(A) Polycarbonate Resin

A bisphenol A based polycarbonate resin (weight average molecular weight (Mw): 28,000 g/mol, melt index (MI): 8 g/10 min (300° C., load: 1.2 kg)) is used.

(B) Polyalkylene Glycol Compound

Polypropylene glycol (number average molecular weight (Mn): 2,000 g/mol) is used.

(C) Epoxy Ester Compound Comprising an Ester Group and an Epoxy Group

(C1) A compound represented by Formula 1a is used.

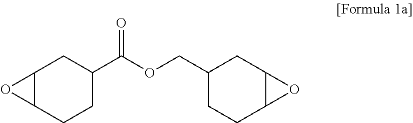 [SMILES: O=C(OCC1CCC2OC2C1)C1CCC2OC2C1]

(C2) A compound represented by Formula 1b is used.

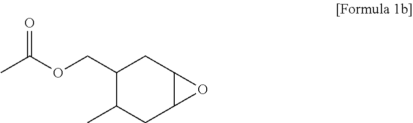

(C3) A compound represented by Formula 1c is used.

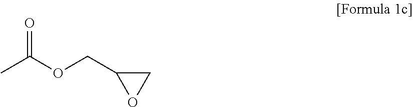

(D) As an ester compound, A compound represented by Formula 2 is used.

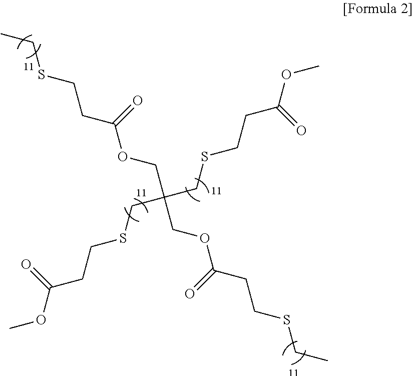

### Examples 1 to 5 and Comparative Examples 1 to 3

### Preparation of Polycarbonate Resin Composition

As listed in the following Table 1, the (A) polycarbonate resin, the (B) polyalkylene glycol compound, the (C) epoxy ester compound comprising an ester group and an epoxy group, and, optionally, the (D) ester compound are blended, followed by extrusion using a twin-screw extruder (L/D=36, Φ=32) at 270° C., thereby preparing a polycarbonate resin composition which is produced into pellets through a pelletizer. The pellet-shaped polycarbonate resin composition is dried in an oven at 100° C. for 2 hours, followed by injection molding in an injection molding machine (DHC 120WD, Dongshin Hydraulics Co.) at a molding temperature of 270° C. and a mold temperature of 70° C. to prepare 3.2 mm thick specimens. Properties of the prepared specimens are evaluated by the following methods, and results are shown in Table 1.

Property Evaluation

(1) Color stability evaluation: In accordance with ASTM D1925, the yellow index (YI) of a 3.2 mm thick specimen of each of the polycarbonate resin compositions is measured before irradiation with γ-rays and 1 day and 7 days after irradiation with γ-rays, followed by calculating a yellow index difference (ΔYI) according to Equation 1:

ΔYI=YI₁−YI₀ [Equation 1]

wherein YI₀ is the yellow index (YI) of the specimen of the polycarbonate resin composition having a thickness of 3.2 mm, as measured in accordance with ASTM D1925 before irradiation with γ-rays, and YI₁ is the yellow index (YI) of the specimen, as measured in accordance with ASTM D1925 1 day and 7 days after irradiation with γ-rays at 25 kGy.

(2) Hydrolysis resistance evaluation (moist heat evaluation): By a yellow index (YI) measurement method in accordance with gel permeation chromatography (GPC) and ASTM D1925, the weight average molecular weight (Mw) and the yellow index of a 3.2 mm thick specimen of each of the polycarbonate resin compositions are measured. Then, the specimen is placed in an autoclave and maintained under steam conditions of 2 bar and 120° C. for 16 hours, followed by measurement of the weight average molecular weight and the yellow index of the specimen by the same method. Then, a weight average molecular weight difference (ΔMw) and a yellow index difference (ΔYI) between before and after moist heat evaluation are calculated.

(3) Thermal stability evaluation (dwell injection evaluation): By the yellow index (YI) measurement method in accordance with GPC and ASTM D1925, a 2.5 mm thick specimen of each of the polycarbonate resin compositions is prepared by injection molding at 320° C. without dwelling in a cylinder of an injection molding machine and measured as to the weight average molecular weight (Mw) and the yellow index, and a 2.5 mm thick specimen of each of the polycarbonate resin compositions is prepared by injection molding after being left at 320° C. for 3 minutes in the cylinder of the injection molding machine and measured as to the weight average molecular weight and the yellow index. Then, a weight average molecular weight difference (ΔMw) and a yellow index difference (ΔYI) between before and after dwelling in the injection molding machine are calculated.

TABLE 1

| | | Example | | | | | Comparative Example | | |
|---|---|---|---|---|---|---|---|---|---|
| | | 1 | 2 | 3 | 4 | 5 | 1 | 2 | 3 |
| (A) (parts by weight) | | 100 | 100 | 100 | 100 | 100 | 100 | 100 | 100 |
| (B) (parts by weight) | | 0.4 | 0.4 | 0.4 | 0.4 | 0.4 | 0.4 | — | 0.4 |
| (C) (parts by weight) | (C1) | 0.04 | 0.06 | 0.1 | — | — | — | 0.1 | — |
| | (C2) | — | — | — | 0.06 | — | — | — | — |
| | (C3) | — | — | — | — | 0.06 | — | — | — |
| (D) (parts by weight) | | — | — | — | — | — | — | — | 0.1 |
| ΔYI between before | 1 day | 33.9 | 29.0 | 29.0 | 31.0 | 32.0 | 39.1 | 45.2 | 37.0 |
| and after γ-ray | 7 days | 19.8 | 18.0 | 19.5 | 20.0 | 20.0 | 20.3 | 32.0 | 20.8 |
| irradiation | | | | | | | | | |
| Moist heat | ΔMw | 1.4k | 1.0k | 1.2k | 1.5k | 1.6k | 1.8k | 1.3k | 1.2k |
| evaluation | ΔYI | 0.56 | 0.15 | 0.20 | 0.41 | 0.50 | 2.85 | 0.55 | 0.23 |
| Dwell injection | ΔMw | 1.7k | 1.2k | 1.6k | 1.8k | 1.8k | 1.9k | 1.5k | 1.8k |
| evaluation | ΔYI | 0.85 | 0.55 | 0.80 | 0.85 | 0.90 | 0.97 | 1.30 | 0.82 |

From the result shown in Table 1, it can be seen that the polycarbonate resin composition according to the present invention has a yellow index difference (ΔYI) (7 days) of 20 or less after irradiation with ionizing radiation, a weight average molecular weight difference (ΔMw) of 1,600 g/mol or less and a yellow index difference (ΔYI) of 0.6 or less after moist heat evaluation, and a weight average molecular weight difference (ΔMw) of 1,800 g/mol or less and a yellow index difference (ΔYI) of 0.9 or less after dwell injection evaluation, thereby exhibiting excellent properties in terms of color stability, hydrolysis resistance, and thermal stability after irradiation with ionizing radiation.

Conversely, the polycarbonate resin composition of Comparative Example 1, which did not include the (C) epoxy ester compound comprising an ester group and an epoxy group, exhibits lower color stability and lower thermal stability, and much lower hydrolysis resistance (moist heat evaluation) than the polycarbonate resin compositions of Examples; the polycarbonate resin composition of Comparative Example 2, which did not include the (B) polyalkylene glycol compound, exhibits significant deterioration in color stability (ionizing radiation resistance) and thermal stability after irradiation with ionizing radiation; and the polycarbonate resin composition of Comparative Example 3, which is prepared using a typical hydrolysis resistant compound instead of the epoxy ester compound comprising an ester group and an epoxy group according to the present invention, exhibits deterioration in color stability (ionizing radiation resistance).

Although some embodiments have been described herein, it should be understood that these embodiments are provided for illustration only and are not to be construed in any way as limiting the present invention, and that various modifications, changes, alterations, and equivalent embodiments can be made by those skilled in the art without departing from the spirit and scope of the invention. Therefore, the scope of the present invention should be defined by the appended claims and equivalents thereof.

What is claimed is:

1. A polycarbonate resin composition comprising:
a polycarbonate resin;
a polyalkylene glycol compound; and
an epoxy ester compound comprising an ester group and an epoxy group.

2. The polycarbonate resin composition according to claim 1, comprising the polyalkylene glycol compound in an amount of about 0.001 to about 5 parts by weight, and the epoxy ester compound comprising an ester group and an epoxy group in an amount of about 0.001 to about 3 parts by weight, each based on about 100 parts by weight of the polycarbonate resin.

3. The polycarbonate resin composition according to claim 1, wherein the epoxy ester compound comprising an ester group and an epoxy group comprises a compound represented by Formula 1: 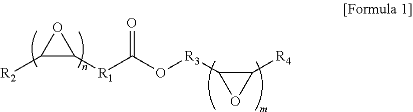
wherein R₁ and R₃ are the same or different and are each independently a C₁ to C₁₀ hydrocarbon group; R₂ and R₄ are the same or different and are each independently a hydrogen atom or a C₁ to C₁₀ hydrocarbon group; R₁ and R₂ are optionally connected to each other to form a ring; R₃ and R₄ are optionally connected to each other to form a ring; m and n are independently 0 or 1; and m+n is 1 or 2.

4. The polycarbonate resin composition according to claim 1, wherein the epoxy ester compound comprising an ester group and an epoxy group comprises a compound represented by Formula 1a:

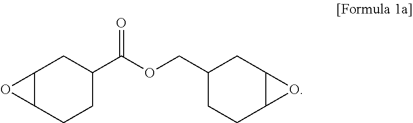 [SMILES: O=C(OCC1CCC2OC2C1)C1CCC2OC2C1]

5. The polycarbonate resin composition according to claim 1, wherein the epoxy ester compound comprising an ester group and an epoxy group comprises a compound represented by Formula 1b:

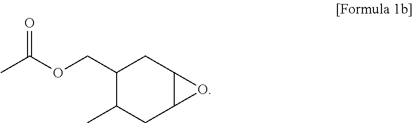

6. The polycarbonate resin composition according to claim 1, wherein the epoxy ester compound comprising an ester group and an epoxy group comprises a compound represented by Formula 1c:

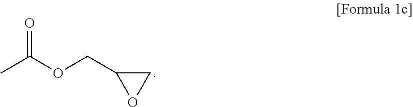

7. The polycarbonate resin composition according to claim 1, wherein the content of the polyalkylene glycol compound is larger than the content of the epoxy ester compound comprising an ester group and an epoxy group, and the sum of the contents of the polyalkylene glycol compound and the epoxy ester compound is about 0.002 to about 5 parts by weight based on about 100 parts by weight of the polycarbonate resin.

8. The polycarbonate resin composition according to claim 1, wherein the polycarbonate resin composition has a yellow index difference (ΔYI) of about 20 or less, as measured on a specimen having a thickness of about 3.2 mm and calculated according to Equation 1:
ΔYI=YI₁−YI₀ [Equation 1]
wherein YI₀ is the yellow index (YI) of a specimen of the polycarbonate resin composition having a thickness of about 3.2 mm, as measured in accordance with ASTM D1925 before irradiation with γ-rays, and YI₁ is the yellow index (YI) of the specimen, as measured in accordance with ASTM D1925 about 7 days after irradiation with γ-rays at about 25 kGy.

9. The polycarbonate resin composition according to claim 1, wherein the polycarbonate resin composition has a weight average molecular weight difference of about 1,600 g/mol or less and a yellow index difference (ΔYI) of about 0.6 or less, as measured on a specimen of the polycarbonate resin composition having a thickness of about 3.2 mm after treatment with steam under conditions of about 120° C. and about 2 bar for about 16 hours.

10. The polycarbonate resin composition according to claim 1, wherein the polycarbonate resin composition has a weight average molecular weight difference of about 1,800 g/mol or less and a yellow index difference (ΔYI) of about 0.9 or less, as measured on a specimen of the polycarbonate resin composition having a thickness of about 2.5 mm and prepared by injection molding after being left in an injection molding machine at about 320° C. for about 3 minutes.

11. A molded article formed of the polycarbonate resin composition according to claim 1.

12. The molded article according to claim 11, wherein the molded article comprises an ionizing radiation resistant medical appliance.
